(19) United States
(12) Patent Application Publication
(10) Pub. No.: US 2014/0120309 A1
(43) Pub. Date: May 1, 2014

(54) LAMINATE WINDOW FILM HAVING MICRO THROUGH HOLES

(71) Applicant: Shigeyoshi Ishii, Hachiouji-city (JP)

(72) Inventor: Shigeyoshi Ishii, Hachiouji-city (JP)

(21) Appl. No.: 14/128,409

(22) PCT Filed: Jun. 26, 2012
(86) PCT No.: PCT/US2012/044263

§ 371 Date: Dec. 20, 2013

(30) Foreign Application Priority Data
Jun. 30, 2011 (JP) JP2011-146270

(51) Int. Cl. B32B 3/26; B32B 25/20

(52) U.S. Cl. CPC B32B 3/266; B32B 25/20
USPC 428/137

(57) ABSTRACT

A window adhesion laminated layer film includes a plastic film layer, and a silicone rubber layer, which has a surface that adheres to a window, wherein the window adhesion laminated layer film has 1 or more pierced through pores per 100 cm square; and wherein the above described silicone rubber layer does not have adhesive properties or bonding properties

### BACKGROUND

The present disclosure relates to a laminated layer film containing a plastic film layer and a silicone rubber layer that adheres to glass, acrylic etc., windows.

On the windows of buildings etc., films that can adhere on windows have been used with the goal of preventing the sun radiation and the scattering of broken glass. Also available are films for adhering on windows like the films, which can provide shelter from the infrared light, etc., and which have little color change, the films for adhering on windows where an adhesive (bonding) agent is contained with the goal that after it has been adhered onto the window it can be separated without residual adhesive or glue, and also the films for adhesion on windows where on the surface of the film for adhesion on windows, numerous pores that pierce through the substrate material and the adhesive agent are provided, with the goal that through that, at the time when the films are adhered onto the window there is air remaining in the space between the films used for adhesion on windows and the surface subject to the adhesion, and as items related to these the following here below references can be stated.

In Patent Application Hei-Sei 10-250004, a film for adhesion on windows has been reported where on one surface of a biaxially oriented polyester film a cover layer, containing a cover layer forming resin, which has as its main components an acrylic type resin (A) and a saturated polyester type resin (B), and an ultraviolet light absorbing agent (C), in the amount in the range of 5˜40 weight parts relative to 100 weight parts of the cover film forming resin, is formed, and on the other surface an adhesive (bonding) agent film, is formed.

In Japanese Patent Application Publication No. 2000-96009, a laminated layer film for adhesion on windows has been reported that is characterized by the fact that it is a laminated layer film where on at least one surface side of the plastic film (A) an adhesive agent layer (B) has been provided, and that it satisfies all of the conditions regarding shown below properties of the above described laminated layer film at the time when the adhesive agent layer side surface has been glued onto a glass plate are:
(1) The normal condition adhesive strength is at least 300 g/cm or higher.
(2) At the time when the holding strength was measured under conditions of a load of 1 kg and a temperature of 80° C., the deviation after 1 hour was 3 mm or less.
(3) The adhesive strength after holding for 6 hours after it has been adhered on glass after spraying with water, is 20% or more of the measured under normal condition adhesion strength.
(4) At the time when it has been adhered onto glass and has been left for 1 week period at a temperature of 70 degrees C. and then it is separated, the number of residual adhesive agent material adhered onto the glass substrate, which has a size of 1 mm square or larger, per 100 cm2, is 1 or less.

In Japanese Patent Application Publication No. 2000-117918, heat ray reflecting film, which is appropriate for outdoor use, has been reported that is characterized by the fact that it is a laminated layer film provided with a weather resistant properties possessing biaxially oriented polyester film used as the substrate material (A), the heat rays reflecting layer (B) that is provided on at least one surface side of the above substrate material and the surface protection layer (C); where for the above laminated layer film, the visual light transmittance is at least 50% or higher, the near infrared light reflectance is at least 50% or higher, and also the haze value is 5% or less.

In Patent Application Hei-Sei 07-164873, a sunshade car film has been reported, which is a car film used for sunshade, which is adhered on the glass surfaces of automobiles and which has a structure that is formed from a film main body, which is formed from a transparent plastic resin formed at the desired thickness and shape, an adhesive agent layer, which has been adhered at the desired thickness on the back surface of the above main film body, and formed at the specified thickness and shape transparent plastic resin release film that can be freely adhered and separated to the adhesive agent layer of the above described main film body; where numerous air conducting pore have been provided at predetermined locations as they pierce through from the front surface of the above described adhesive agent layer, through the above adhesive agent layer and to one part of the above described release film.

In United States Patent 2004-061032A1, an adhesive sheet has been reported that is an adhesive sheet, which contains a substrate material and an adhesive agent layer, and where numerous through pores are formed that pierce through from one surface to the other surface; where the diameter of the piercing through pores in the above described substrate material and adhesive agent layer is in the range of 0.1˜300 microns and the pore density is in the range of 30˜50,000 units/100 cm2.

### SUMMARY

As described here above, in the case of the window glass adhesive film, in order to equip it with a performance that prevents the scattering of broken window glass, it has a sufficient adhesive strength relative to the window glass, and thus, it cannot be separated from the glass or it can be separated only by using special chemical agents, etc., and such films have been difficult to handle. Then, in the case of the window glass adhesive films containing air conducting pores, because of the high adhesive strength needed for the prevention of the window glass scattering, for example, even in the case of the types of films using adhesive agents, according to the usual consumers the following difficulties have been cited: 1) when adhered onto large surface areas the handling becomes poor and the adhesion is difficult; 2) in order to not have air bubbles it is necessary to provide numerous pores per unit surface area and a sense of non-transparency is felt; 3) in order to absorb the air bubbles it is necessary to press strongly with the fingers etc., 4) even in the case when film release properties have been imparted, it is difficult to achieve separation without having residual adhesive agent.

The problem that is the topic of the present disclosure is to suggest a window adhesive laminated layer film with high weather resistant properties, high transparency properties and high aesthetic properties, where even in the case of normal consumers who are not professional craftsmen, especially even for buildings or automobiles etc., windows, even when they have large surface area, the film can be easily adhered and then the generation of air bubbles is suppressed and also, even if there are remaining fine air bubbles, through a simple squeegee, etc., light operation, it is possible to sufficiently eliminate the air bubbles and the operation time is significantly decreased and then also the film can be easily removed from the window without residual adhesive layer or the generation of adhesive traces.

It has been observed that by providing a laminated layer film that adheres on a window, which does not have adhesive or bonding properties, and that is provided with pierced through pores that have pore diameter and pitch corresponding to the adhesive strength, it is possible to solve the above described problem.

According to one aspect of the present invention, a window adhesive laminated layer film can be provided, which is a window adhesive laminated layer film containing pierced through pores of at least 1 unit or more per 100 cm2 and that contains a plastic film layer and a silicone rubber layer, which has a window adhesion surface; where the above described silicone rubber layer does not have adhesive or bonding properties.

In the case of the 1 or more pierced pore per 100 cm2 containing, laminated layer film according to one aspect of the present invention, a layer laminated film is used where the silicone rubber layer inside the laminated layer film does not have adhesive or bonding properties and it is adhered on the window, and due to that it is easy to be removed from the window without residual adhered silicone rubber layer and/or adhesive traces remaining on the window, and then pierced porosity is contained with pore diameter and pore pitch according to the adhesive strength; and by that it is possible to obtain a laminated layer film with high weather resistant properties, high transparency properties and high aesthetic properties, where even in the case of normal consumers who are not professional craftsmen, especially even for building or automobile etc., windows, even when they have large surface area, the film can be easily adhered and then the generation of air bubbles is suppressed and also, even if there are remaining fine air bubbles, through a simple squeegee, etc., light operation, it is possible to sufficiently eliminate the air bubbles and the operation time is significantly decreased and then also the film can be easily removed from the window without residual adhesive layer or the generation of adhesive traces.

In certain embodiments the present disclosure provides a laminated layer film where it is possible to easily expel the air etc., even in the case of large surface areas, and the adhesion separation is easy and there is no reside on the adhesion surface after the separation. The solution is possible by suggesting a window adhesion laminated layer film that in one embodiment is a window adhesion laminated layer film that contains a plastic film layer, and a silicone rubber layer, which has a surface that adheres to the window, and that has 1 or more pierced through pores per 100 cm square; and wherein the above described silicone rubber layer does not have adhesive properties or bonding properties.

### BRIEF DESCRIPTION OF THE FIGURES

FIG. 1 represents a sectional view of a laminated layer film containing pierced through porosity according to one embodiment of the present invention.

FIG. 2 represents a top view of a laminated layer film containing pierced through porosity according to one embodiment of the present invention.

FIG. 3 represents a model diagram showing the condition when the air or water in the space between the laminated layer film containing pierced through porosity and the surface subject to the adhesion, is moved.

FIG. 4 shows a laminated layer film containing pierced through porosity where a metal layer has been layer laminated on the silicone rubber layer side on the surface of the plastic film layer.

FIG. 5 shows a laminated layer film containing pierced through porosity where a printing layer has been layer laminated on the silicone rubber layer side on the surface of the plastic film layer.

FIG. 6 shows a laminated layer film containing pierced through porosity where a printing layer has been layer laminated on side opposite to the silicone rubber layer side on the surface of the plastic film layer.

### DETAILED DESCRIPTION

Here below, representative practical implementation conditions for the present invention will be described in detail as examples; however, the present disclosure is by no means limited to those practical implementation conditions.

In one embodiment, the window adhesive layer laminated film according to the present invention is a window adhesive layer laminated film containing pierced through pores of at least 1 unit or more per 100 cm2 and that contains a plastic film layer and a silicone rubber layer, which has a window adhesion surface; where the above described silicone rubber layer does not have adhesive or bonding properties.

In the case of this laminated layer film, because of the fact that the silicone rubber layer inside the laminated layer film does not have adhesive or bonding properties it is easy to be removed from the window without residual adhered silicone rubber layer and/or adhesive traces remaining on the window. Then, by using a laminated layer film where pierced porosity is contained with pore diameter and pore pitch according to the adhesive strength, it is possible to obtain a laminated layer film with high weather resistant properties, high transparency properties and high aesthetic properties, where even in the case of normal consumers who are not professional craftsmen, it is possible to easily adhere large surface areas of the film by a simple operation and in a short amount of time and easily and sufficiently perform the air suction and there is small markings etc., due to the fact that it is a large surface area, and also the aesthetic properties are excellent.

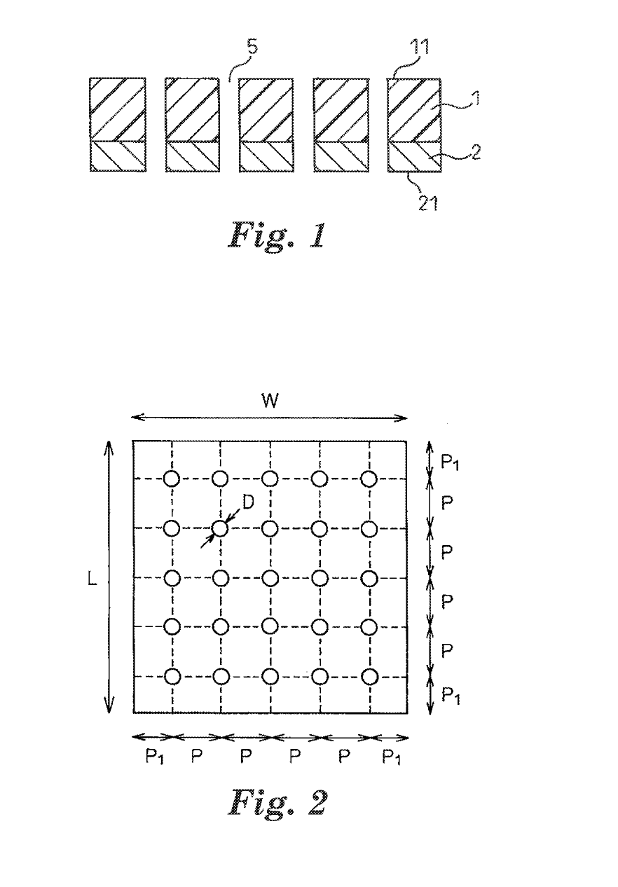

In FIG. 1 the sectional view diagram of a laminated layer film containing pierced through porosity of at least 1 unit or more per 100 cm2, according to one embodiment of the present invention is presented. On one surface of the plastic film layer 1 the silicone rubber layer 2, which contains the window adhesive surface 21, is layer laminated, and the pores 5, which pierce through from the top surface 11 of the laminated layer film to the adhesive surface 21, are contained, and then it can be adhered onto the window through the adhesive surface 21.

In FIG. 2 a diagram of the laminated layer film containing pierced through porosity of at least 1 unit or more per 100 cm2, is shown as viewed from the side of the top surface 11. Inside the laminated layer film of width W×length L, numerous pores with a pore diameter D are provided where the distance between the end of the film and the middle of the pore is P1 and where the pore pitch is P.

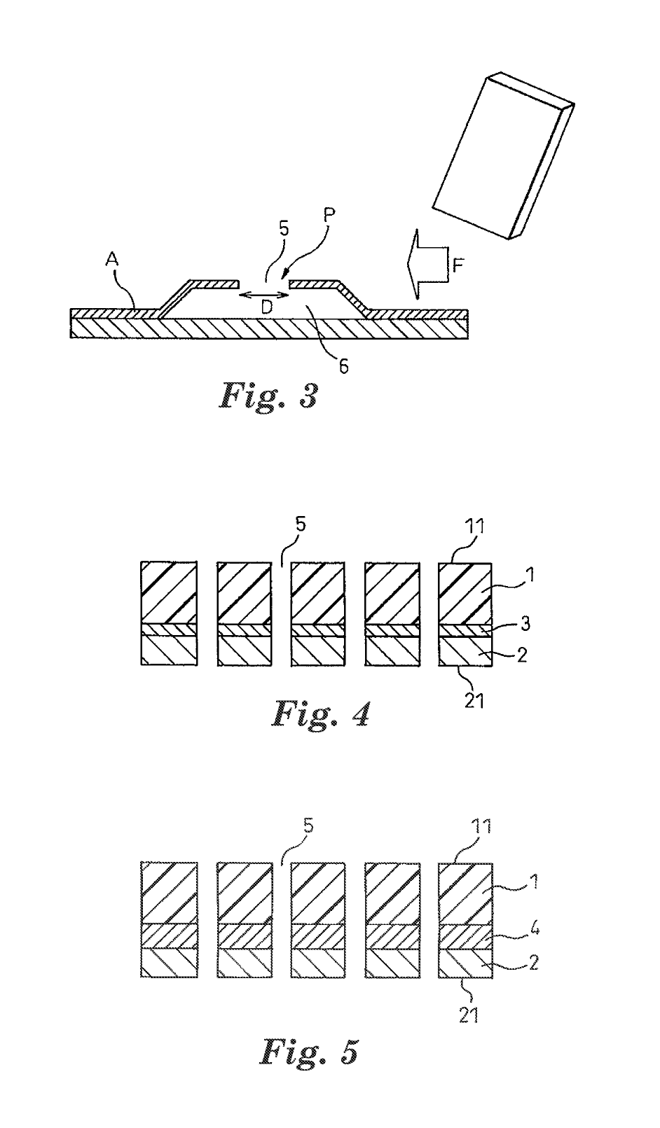

In FIG. 3 a model diagram showing the condition when the air or water, etc., in the space between the laminated layer film containing pierced through porosity of at least 1 unit or more per 100 cm2, and the surface subject to the adhesion, is moved, is shown. For example, in the case when the film is adhered to the surface subject to the adhesion at an adhesion strength A, by applying a force F through a squeegee, etc., the air, water, etc., 6, which is present in this space is easily moved and it is expelled through the pierced through pores 5 with a diameter D.

In FIG. 4 a sectional view of a different from the above, laminated layer film containing pierced through porosity of at least 1 unit or more per 100 cm2is shown. On the surface of the plastic film layer 1, on the silicone rubber layer side 2, a metal layer 3 is layer laminated and especially, a silicone rubber layer 2, which contains the window adhesive surface 21, is layer laminated.

In FIG. 5 a sectional view of yet another laminated layer film, containing pierced through porosity of at least 1 unit or more per 100 cm2 is shown. On the surface of the plastic film layer 1, on the silicone rubber layer side 2, a printing layer 4 is layer laminated and especially, a silicone rubber layer 2, which contains the window adhesive surface 21, is layer laminated.

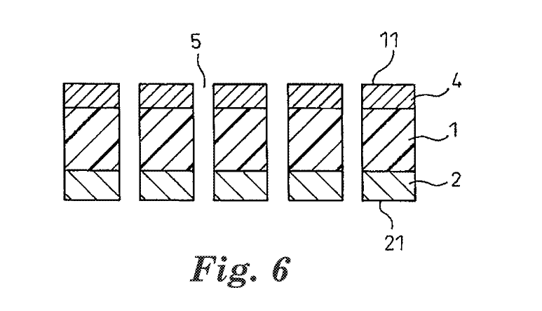

In FIG. 6 especially, a sectional view of yet another laminated layer film, containing pierced through porosity of at least 1 unit or more per 100 cm2, according to another embodiment of the present invention is shown. On one surface of the plastic film 1, the silicone rubber layer 2, which contains the window adhesive surface 21, is layer laminated and on the top of the surface of the plastic film layer 1 that is on the opposite side of the silicone rubber layer 2, the printing layer 4, is layer laminated.

The below terms that are used throughout the description of the present disclosure have the described correspondingly meaning shown below.

The term “adhesion” means that through adhesion or bonding, the adhered material becomes as one body with the material subject to the adhesion and it cannot be detached, and after the separation of the adhered material there is no cohesive failure of the adhered material.

The term “bonding” includes both pressure sensitive adhesion and adhesion.

The term “bonding imparting agent” has the meaning of a material, which can be added to the silicone rubber layer in order that, through lowering the room temperature elastic modulus it would increase the properties of being able to follow the fine surface of the glass and increase the anchor effect.

The terms “pore diameter” represent the maximum dimension of the pore size according to the pore shape when viewed from the piercing direction of the pore.

The term “pore pitch” represents the distance between the center points of any one pore and the pore that is in a position that is the closest to that one pore.

The term “window” has the meaning of glass, plastic, etc., made plate that has a thickness.

The term “transparent” has the meaning that a visible light beam, namely within the wavelength range of 380 nm˜780 nm, the light beam transmittance is at least 80% or higher.

Regarding the silicone rubber layer, there are no specific limitations and it is possible to use the materials that are generally known as silicone rubbers. Especially, if as the silicone rubber layer, as it is shown here below, the materials are used that are obtained as a silicone main agent containing reactive poly dimethyl siloxane etc., and a crosslinking agent, are mixed and combined under the presence of a catalyst, and it is cured on the surface of the plastic film layer, then the adhesive strength between the plastic film layer and the silicone rubber layer becomes sufficient and also, it is possible to easily obtain the silicone rubber layer. For the combination of the silicone main agent, the crosslinking agent and the catalyst, it is possible to use the following three types: i) the condensation type (wet curing type) method where as the main silicone agent, terminal hydroxyl radical containing poly dimethyl siloxane and/or poly dimethyl siloxane and poly diphenyl diphenyl siloxane copolymers, etc., are used, as the crosslinking agent, poly-functional —Si(OCH3)3 type crosslinking agents, etc., are used, and as the catalyst, dibutyl lead dilaurate, etc., is used, ii) the adduction method where as the main silicone agent vinyl radical containing poly dimethyl siloxane and/or polydimethyl siloxane and poly diphenyl siloxane copolymers etc., are used, and as the crosslinking agent, Si—H containing siloxane type crosslinking agents, etc., are used and as the catalyst, platinum catalyst, etc., is used, and iii) the silicone poly urea type method where as the silicone main agent terminal amine radical containing poly dimethyl siloxane and/or poly dimethyl siloxane and poly diphenyl siloxane copolymers, etc., are used, and as the crosslinking agent, poly isocyanate radical containing crosslinking agents, etc., are used, and as the catalyst, dibutyl lead dilaurates, etc., are used.

Regarding the weight average molecular weight of the silicone main agent, there are no particular limitations, and it can be a material where it is approximately 50,000 or higher, approximately 100,000 or higher, approximately 200,000 or higher, approximately 300,000 or higher, and it can be a material where it is approximately 2,000,000 or lower, approximately 1,000,000 or lower, approximately 500,000 or lower, approximately 400,000 or lower. Regarding the weight average molecular weight of the silicone main agent, if it is approximately 300,000 or higher and approximately 500,000 or lower, it is appropriate because it is easy to be appropriately used.

Regarding the mole amount of the crosslinking agent that is used relative to the reactive radical in 1 mole of the silicone main agent, for example, the terminal hydroxyl radical in the case of the condensation method, the vinyl radical in the case of the adduction method, the terminal amino radical in the case of the silicone poly urea method, there are no specific limitations as long as there is no deterioration of the adhesive properties after curing, and it is possible that it be approximately 0.5 or higher, approximately 1.0 or higher, approximately 1.5 or higher, and approximately 3.0 or lower, approximately 2.0 or lower.

Regarding the mole amount of the crosslinking agent relative to 1 mole of the silicone main agent, so that as much as possible there is no remaining unreacted silicone main agent or crosslinking agent, etc., that remains after the curing, in the case of the condensation or the adduction method, it is appropriate to be approximately 0.5˜approximately 3.0, and in the case of the silicone poly urea method it is appropriate to be in the range of approximately 0.5˜approximately 1.5. Regarding the mole amount of the crosslinking agent relative to 1 mole of the silicone main agent, when it is approximately 1.0, it becomes an equivalent amount and because of that it is suitable.

Regarding the state of the crosslinking of the silicone main agent and the crosslinking agent, as it is shown in details here below, it can be represented through the gel component ratio of the silicone rubber layer after the curing.

Moreover, in the case when the silicone rubber layer contains the described here below adhesion imparting agent, the contained amount of this adhesion imparting agent is not included in this gel component ratio.

Regarding the gel component ratio, it can be a material that has a gel component ratio that is approximately 90% or higher, approximately 95% or higher, approximately 98% or higher, approximately 99% or higher, approximately 99.8% or higher, and if it is approximately 90% or higher, it is appropriate as after the separation, there are almost no residual adhesive traces on the glass surface, and from the point of view of a superior degree where after the separation there are no residual adhesive traces etc., at all on the glass surface, it is preferred if it is approximately 99% or higher, and then it is especially preferred if it is approximately 99.8% or higher.

In the crosslinking reaction between the silicone main agent and the crosslinking agent, optionally, it is possible to use a catalyst. In that case, the amount of the catalyst relative to the silicone main agent and the crosslinking agent, in the case of the condensation method or the silicone poly urea method, by weight, can be approximately 0.0001% or higher, approximately 0.00015% or higher, approximately 0.001% or higher, and approximately 3.0% or lower, approximately 2.0% or lower, approximately 1.0% or lower, and in the case of the adduction method, by weight, it can be approximately 1.00 ppm or higher, approximately 2.0 ppm or higher, approximately 5.0 ppm or higher, and approximately 100 ppm, or lower, approximately 90 ppm or lower, approximately 80 ppm or lower.

Regarding the amount of catalyst relative to the silicone main agent and the crosslinking agent, by weight, if in the case of the condensation method or the silicone poly urea method, it is in the range of 0.0001˜3.0% and in the case of the adduction method in the range of 1˜100 ppm, the reaction proceeds sufficiently and there is no change with the passing of the time, and there is no deterioration of the properties of the silicone rubber layer after the curing, and because of that it is suitable.

Regarding the silicone rubber layer, it adheres non-selectively on glass, plastic etc., window materials, for example, in the case when it is adhered on a glass that is used for window glass, and measured as pierced porosity containing, laminated layer film used for window adhesion, by using the 90 degree peel (separation) test conducted according to the JIS K6854-1, whose measurement details are shown here below, it can be a layer that has an adhesive strength of approximately 0.01 N/m or higher, approximately 0.05 N/m or higher, approximately 0.1 N/m, On the other hand, it can be a layer that has an adhesive strength that is approximately 15 N/m or lower, approximately 10 N/m or lower, approximately 5N/m or lower.

As the thickness of the silicone rubber layer, there are no particular limitations as long as there is no generation of separation, etc., through dead weight etc., after the adhesion, and as the weight after curing, it can be approximately 40 microns or less, approximately 30 microns or less, approximately 25 microns or less, approximately 20 microns or less, approximately 15 microns or less, approximately 10 microns or less, and on the other hand, in order to form a smooth silicone rubber layer that does not have waviness or protrusions and indentations on its surface, it is possible to be a layer with a thickness that is approximately 0.3 microns or higher, approximately 0.5 microns or higher, approximately 0.7 microns or higher, approximately 1.0 microns or higher, approximately 2.0 microns or higher.

Regarding the thickness of the silicone rubber layer, if it is too thin, it becomes difficult to adhere onto the material subject to the adhesion and because of that it is appropriate if the thickness is in the range of 0.5 microns or higher, and then it is appropriate if it is at least 1.0 microns or higher. Then, regarding the thickness of the silicone rubber layer, from economical point of view, it is appropriate if it is 30 microns or less, and then it is appropriate if it is 20 microns or less.

Regarding the silicone rubber layer, fundamentally other additive agents, etc., are not contained, however, if necessary, it is possible that it contains the additives reported here below for the plastic film layer and the metal layer location.

Regarding the silicone rubber layer, practically, it generally does not contain adhesion imparting agents known by those skilled in the industry, namely, for example, the materials used in order to increase the properties of following the micro surface of the glass and by that increase the anchor effect, through lowering the room temperature elastic modulus.

However, as long as there is no deterioration of the weather resistant properties, the adhesion properties, etc., of the silicone rubber layer, there are no particular limitations and it is possible to add generally used adhesion imparting agents. In particular, as adhesion imparting agents, for example, it is possible to reference the MQ resin.

Regarding the MQ resin, for example, it is a solid phase resin with a structure, which contains in its molecule R3SiO— (M body) and SiO4- (Q body), and usually it has a weight average molecular weight that is in the range of 10,000˜150,000; materials where the M body relative to 1 mole of the Q body is in the range of 0.7˜1.1 moles, can be used. It can be used as it is mixed and dissolved into the silicone main agent etc., and after that it is cured.

Regarding the silicone rubber layer, it is possible to be a material that contains an adhesion imparting agent in an amount, by weight, of approximately 15% or less, approximately 10% or less, approximately 5% or less, and it is a material that contains approximately 0.1% or more, approximately 1% or more. Moreover, regarding the commercially available usual adhesive agents, it is known that usually, they are materials that contain adhesion imparting agents in the amount of 50 weight % or more of the MQ resin, etc.

Even in the case when the silicone rubber layer contains adhesion imparting agent, the thickness and the adhesive strength etc., of the silicone rubber layer can be adjusted within the range described for the case of the silicone rubber layer that does not contain the above described adhesion imparting agents.

In the silicone rubber layer, usually, through the described here below protective sheet, etc., it is made so that dust, dirt, etc., deposit materials are not adhered, and it can be well adhered onto a window. However, optionally, it is also possible that water or solvent agent, surface active agent, etc., are sprayed onto the window or the silicone rubber layer, etc., and by that it is appropriately used and after that it is adhered.

Regarding the plastic film layer, there are no particular limitations, and for example, it is possible to use films made from polyester, polyamide, polyolefins, polyvinyl chloride, polycarbonates, acrylic type resins, fluorinated resins, etc.

Also, regarding the structure of the plastic film layer, optionally, it is also a good option if in order to adjust the reflectance or the transmittance, etc., through co-extrusion, etc., a multi-layer structure is prepared formed from any type of number of layers.

Even among these, from the point of view of the transparency properties, the dimensional stability properties and the economical properties, etc., polyesters, polycarbonates, acrylic type resins and polyolefins are suitable. Then, especially, from the point of view of the transparency properties, the economical properties, the weather resistance properties, the heat resistance properties, the mechanical properties, etc., the polyester films are appropriate. In the case of the polyester films, there are no particular limitations and depending on the applications, it is possible to use uniaxially oriented polyester films, biaxially oriented polyester films, or non-oriented polyester films, etc.

Regarding the thickness of the plastic film layer, there are no particular limitations as long as there are no problems related to the flexibility properties, etc., and it is possible to use materials with a thickness of approximately 200 microns or less, approximately 100 microns or less, approximately 50 microns or less, and a material that is approximately 10 microns or more, approximately 20 microns or more, approximately 30 microns or more. Regarding the thickness of the plastic film layer, when it is approximately 30 microns or more and also approximately 100 microns or less, it is appropriate because the handling at the time of the adhesion onto the window is easy.

Regarding the plastic film layer, then, optionally, depending on the requirements, it is also possible to be a material that contains anti-electrostatic agent, stabilizing agent, lubricant agent, crosslinking agent, anti-blocking agent, anti-oxidation agent, ultraviolet light absorption agent, infrared light absorption agent, light beam isolation agent, design imparting agents like coloring agents, etc., lubricant agents used in order to improve the handling at the time of the wet adhesion etc., processing, etc.

Through the plastic film layer, for example, through the use of both infrared light absorption agent and ultraviolet light absorption agent, it is possible that without decreasing the transmittance for the visible light, the transmittance of the ultraviolet light and the infrared light is decreased. Then, for example, if a plastic film layer, which has a multi-layer structure that selectively reflects light in the near infrared region and an infrared light absorption agent and an ultraviolet light absorption agent, it is possible to make a material that only decreases the transmittance of the infrared light and the ultraviolet light without decreasing the transmittance for the visible light.

Regarding the laminated layer film, it is possible to be a film that contains a metal layer and/or metal compound layer on at least one surface of the plastic film layer, used with the goal to reflect infrared light, ultraviolet light, visible light etc. When a metal layer is used, the transmittance becomes flat for the whole region from the infrared light to the ultraviolet light, and due to the fact that the ones that have absorption in specific regions are generally known, depending on the application, for example, it is possible to use a wide variety of metal layers. As the metal compounds that form the structure of the metal layers, it is possible to use Au, Ag, Cu, Al, etc., metals or alloys. From a cost and reflectance stand point, Al or its alloys are preferred. Besides that, as metal compounds that form the structure of the metal layers, it is also possible to use the generally known ITO (mixtures obtained as several % of tin oxide is added into indium oxide), etc. Moreover, optionally, it is also possible to use two or more types of metal materials together.

Especially, as it is shown in FIG. 4, if a metal layer is present between the plastic film layer and the silicone rubber layer, the metal layer can be protected from friction etc., which is desirable. Also, it is a good option if on the side of the metal layer that is opposite to the side of the plastic film layer, an anti-corrosion coating layer is provided with the goal of preventing the oxidation of the metal layer.

Regarding the light transmittance coefficient of the metal layer, it is possible to be approximately 1% or higher, approximately 5% or higher, and it is also approximately 75% or less, approximately 70% or less, approximately 65% or less, and usually, the materials that have an average value within the range of 5% 20% are widely used, however there are also case where it is appropriate to use materials within the range of 35%˜65%.

There are no particular limitations regarding the metal layer processing method, and for example, the processing can be conducted by performing the usually used methods for the formation of thin metal layers, like the vapor deposition method, the sputtering method, the plasma CVD method, etc. Also, in the case when it is necessary to impart design properties, it is also possible to use dry lamination of metal foils etc.

Regarding the laminated layer film, for example, as it is shown in FIGS. 5 and 6, in order to be decorative, it is also possible to be a film that contains a single layer or a multi-layer printing (printed) layer on the plastic film layer's silicone rubber layer side and/or on its opposite side.

For the formation of the printing layer, it is possible to use screen, gravure, off set, ink jet, electro-static coating, etc., well known methods. From the point of view of using the many types of commercially available weather resistant inks, it is also possible to use the screen printing process. Regarding the printing layer, for example, if it is placed between the plastic and the metal layer, it is appropriate as the color fading due to friction etc., is reduced.

On the contrary, if the printing layer is provided on the side opposite to the silicone rubber layer, for example, it is possible to be printed just before the adhesion of the laminated layer film onto the window, and it becomes possible to perform a timely and at will printing and decoration etc., of public notices, commercial products prices, etc.

Also, it is a good option if instead of printing on the surface of the plastic film layer, a coloring agent is contained so that a decorative pattern etc., can be formed inside the plastic film layer.

Regarding the laminated layer film, with the exception of the case when a coloring agent etc., is contained, for the whole body of the laminated layer film it can be a film that has a visible light transmittance of approximately 10% or higher, approximately 30% or higher, approximately 40% or higher, and it can be a film with a transmittance that is approximately 99.9% or less, approximately 90% or less, approximately 80% or less, approximately 60% or less.

Regarding the laminated layer film, it is also possible to be a film that contains a coating film in the space between the silicone rubber layer and the plastic film, etc., with the goal of increasing the strength of the adhesion between the silicone rubber layer and the plastic layer etc. Also, in order to improve the usability and the adhesion properties of the silicone rubber layer towards the plastic film layer, etc., it is also a good option if prior to the application a chemical treatment or an electro-discharge treatment is performed onto the plastic film layer etc.

In order to increase the scratch resistant properties and/or the stain resistant properties of the outer most surface layer of the laminated layer film, it is possible to provide a scratch resistant layer and/or stain resistant layer on the surface most layer of the plastic film layer or on the printed layer, etc., of the plastic film layer. As the resin that forms the structure of the scratch resistant layer and/or stain resistant layer, for example, it is possible to use the used according to the same methods as those described here below for the silicone rubber layer location thermoplastic resins or thermosetting resins etc., which have excellent weather resistant properties; and as such resins, for example, it is possible to point out fluorine containing resins, acrylic resins, polyvinyl alcohol resins, epoxy resins, unsaturated polyester resins, urethane resins, melamine resins, silicone resins and acryl-silicone resins, etc.

Regarding the scratch resistant layer and/or stain resistant layer, instead of being provided as appropriately upon use, it is also possible that a plastic film layer be used where a scratch resistant layer and/or stain resistant layer has been provided in advance on the front surface.

It is possible to layer laminate a protective sheet on the adhesive surface of the silicone rubber layer. In the protected state of the pierced through porosity containing window adhesive layer laminated film, it is a material that has a scratch resistance and stain resistance, etc., functionality, where the adhesive surface is protected so that there is no adhesion of dust, dirt etc. There are no particular limitations regarding the materials used as the protective sheet, and the sold as general use products PET, PP, etc., which have a thickness that does not generate problems with respect to the flexibility properties, etc., can be used. The protective sheet material itself cannot adhere and because of that it is a good option if there is no pierced porosity present or it is also a good option if the protective sheet contains either not connected (not pierced through) porosity or pierced through porosity, if it has been provided by a technological process with appropriate conditions.

Also, regarding the silicone rubber layer, because of the fact that special release properties, such as those for the protective sheet that is an adhesive layer, are not required, it is possible that instead of the use of a protective sheet, the laminated layer film body itself is wound in a roll form, etc., and by that the body of the surface most of the plastic film layer etc., itself is used as a protective sheet.

As the method for the processing of the silicone rubber layer, as it has been described here above, the well known methods can be used. Especially, it is possible to use the method where on the surface of the plastic film layer, a silicone main agent and a curing agent, are cured under room temperature or under an elevated temperature through the use of catalyst.

The application of the plastic film layer onto the silicone rubber can be conducted at any step of the process. In the case when the viscosity of the silicone main agent is high, in order not to cause adverse effects on the reaction between the silicone main agent and the crosslinking agent, it is possible to adjust the viscosity by using organic solvent agents that have dissolving properties and that are generally used, like ethyl acetate or toluene, etc., and there are no particular limitations.

As the method for the application of the silicone solution containing the silicone main agent, the crosslinking agent and the catalyst, it is possible to use any well known method, for example, it is possible to use the rod coating method, the conma knife coating method, the roll coating method, the blade coating method, the spray coating method, the air knife method, the dip coating method, the kiss coating method, the bar coating method, the die coating method, the reverse roll coating method, the off set gravure coating method, the wire bar coating method, the gravure coating method, the reverse gravure coating method, the roll brush coating method, the spray coating method, the immersion (penetration) method, the spin coating method, and the curtain coating method, etc., and these can be used individually or as a combination.

At the time of the application of the silicone solution containing the silicone main agent, etc., onto the surface of the plastic film layer, optionally (depending on the requirements), in order to improve the adhesion properties and/or the usability properties, it is possible to apply as a pre-treatment on the front surface of the plastic film layer a flame treatment, a corona electrical discharge treatment, a plasma electrical discharge treatment, etc., physical surface treatment, or it is possible to use a primer etc., and by that it is possible to strengthen the adhesive properties between the silicone rubber layer and the plastic film layer.

Regarding the application of the silicone solution containing the silicone main agent, the crosslinking agent and the catalyst, onto the plastic film layer, it is a good option if it is performed directly onto the film according to the above described application methods, and also, it is a good option if it is applied onto the temporary protective sheet and is dried to a certain degree and after that the protective sheet and the plastic film layer are glued and the silicone rubber layer is adhered onto the plastic film layer. Regarding the curing temperature and curing time at this stage, it is preferred that they are conditions that allow for sufficient curing of the silicone rubber.

For the pierced porosity containing laminated layer film, after the described here below detailed explanation of the laminated layer film formation, numerous pierced pores 3 are formed so that they pierce (connect) from the laminated layer film's top surface to the adhesive surface. At the time of the adhesion of the laminated layer film onto the body subject to the adhesion, the air, water etc., that is enclosed and remains in the space between the adhesive surface of the laminated layer film and the body subject to the adhesion, is expelled and lead out through these pierced through pores onto the top surface side of the laminated layer film.

There are no particular limitations regarding the shape of the side cross section of the pierced through pores, and as viewed from the top surface side or the adhesive surface side of the laminated layer film, it can be many different shapes like a circular shape, an oval shape, a rectangular shape, a poly-angle shape, a star shape, etc., correspondingly; and also, it is possible that they are pores where the shape when viewed from the top surface side is different from the shape as viewed from the adhesive surface side; however, when the shape is a circular shape that is the same as viewed from the top surface side and from the adhesive surface side, it is appropriate as it is possible to decrease the manufacturing costs.

Regarding the diameter of the pierced through pores, it is possible that they have diameters that are approximately 0.1 microns or higher, approximately 1 micron or higher, approximately 5 microns or higher, approximately 10 microns or higher, approximately 50 microns or higher, approximately 100 microns or higher, approximately 300 microns or higher, approximately 400 microns or higher, and it is possible that they are pores with diameters that are approximately 3000 microns or lower, approximately 2000 microns or lower, approximately 1500 microns or lower, approximately 1000 microns or lower, approximately 800 microns or lower, approximately 500 microns or lower. The materials where the pore diameters are approximately 300 micron or higher and approximately 200 micron or lower, are preferred. If they are approximately 300 microns or higher, it is appropriate because the pores can be manufactured at a good precision and low cost, and on the other hand, if they are approximately 2000 microns or less, it is appropriate because they are difficult to be seen by the user. Also, optionally, it is possible that the diameter of the pierced through pores be different at the laminated layer film's top surface side and at the adhesive surface side, however, if the diameters are the same it is appropriate because the pores can be manufactured at a good precision and low cost.

Regarding the pierced through pores, if the number of units per unit surface area is too small, it becomes difficult to generate a difference with respect to the air escape as compared to the case of the film that does not have pierced through pores, and because of that in the case of the pierced through porosity containing, window adhesion laminated layer film, the number of units per 100 square cm is at least approximately 1 or more, and it can be a material containing per 100 square cm, approximately 4 units or more, approximately 9 units or more, approximately 16 units or more, approximately 25 units or more, approximately 36 units or more, and approximately 40000 or less, approximately 10000 or less, approximately 4356 or less, approximately 2500 or less, approximately 1600 or less, approximately 1089 or less, approximately 625 or less, approximately 400 or less.

Regarding the pierced through pores pitch, it can be approximately 0.5 mm or more, approximately 1.0 mm or more, approximately 1.5 mm or more, approximately 2.0 mm or more, approximately 2.5 mm or more, approximately 3.0 mm or more, approximately 4.0 mm or more, approximately 5.0 mm or more, and also, approximately 100 mm or less, approximately 50 mm or less, approximately 30 mm or less, approximately 25 mm or less, approximately 20 mm or less, approximately 15 mm or less. If it is approximately 2.0 mm or more, it is appropriate because the density of the pierced pores per unit surface area of the laminated layer film is not too large and the strength of the laminated layer film is maintained, and if it is approximately 30 mm or less, it is appropriate because the escape of the water, air etc., is performed well. Also, in the case when the pore diameter is for example 1000 microns or higher, it is appropriate if the pitch of the pierced through pores is approximately at least 2 times or more the pore diameter, as the strength of the laminated layer film is maintained.

For the laminated layer sheet, it can be manufactured so that the pierced pores are formed so that their centers are at the intersection points of a matrix design with a triangular shape, an orthogonal shape a rectangular shape, a polyhedral shape etc., however, for the placement of the pores, when it is uniform, it is desirable because the movement of the air, water etc., to the pierced pores is easy, and when the distances from any one pierced through pore to the pierced through pore immediately adjacent to it, are the same, for example, only the smallest movement distance in the longitudinal and the cross direction is necessary and because of that then it is an appropriate condition.

Although the goal is not tie it to any theory, according to the model diagram that is shown in FIG. 3, if the force applied by the squeegee is denoted as F, the adhesive strength of the laminated layer film is denoted as A, the diameter of the pierced through pore is denoted as D, the force necessary in order to expel the air, water, etc., from the pierced through pore is denoted as P, and as is set as a constant, then in the case when

F>A>P=a/D (equation 1)

it is though that, through the squeegee with the force F, the air or water etc., in the space between the surface subject to the adhesion and the laminated layer film, is moved, and it is expelled out of the pierced through pores.

By using the laminated layer film according to the present disclosure, because of the fact that it is a film whose silicone rubber layer does not have adhesive or bonding properties, and because of that the value A in the above described (equation 1) becomes significantly smaller compared to the adhesive agent or bonding agent according to the previous technology, and then, when D in the above described (equation 1) is set to be large, by that it becomes possible to expel and lead out the air, water etc., from the pierced through pores easily by using a simple squeegee, etc.

On the other hand, in the case of the adhesive or bonding agent according to the previous technology, the A in the above described (equation 1) is large compared to the adhesion according to the present disclosure, and because of that the movement of the air, water etc., is difficult, and in order to expel that it is necessary that the shortest distance of the outer edge of the adjacent corresponding pierced pores is set to a pore pitch so that it is the same as the level of the allowed residual air bubble size. Also, in the case when pierced through pores are provided that have the same pore pitch as the diameter D, it is generally not possible to maintain the strength of the laminated layer film and in addition to that as a whole body, the open porosity surface becomes large and because of that it becomes a state where it is generally not possible to demonstrate the performance of the original laminated layer film. In order to prevent that, it is necessary that the diameter D of the pierced through pores is made to be a value that is sufficiently small compared to the pore pitch. Even if it is made to be a material that is set to have a pore pitch and pore diameter D that allow the removal of the practically visible residual air bubbles, this causes the decrease of the film transparency properties due to the light scattering caused by the wall surface of the pierced through pores.

Regarding the pierced through pores, there are no particular limitations and they can be manufactured by using the previous technology laser processing, needles, drilling, high pressure water flow, punch-pull method, punching etc.

Regarding the laser that is used in the laser processing method, there are no particular limitations and for example, it is possible to use eximer laser, carbon dioxide (CO2) gas laser, TEA-CO2 laser, YAG laser, UV-YAG laser, semiconductor laser, YVO4 laser, YLF laser, etc.

### EXAMPLES

The measurement of the 90 degree peel was conducted according to the JIS K6854-1. In more details, under room temperature and room humidity, on a washed window glass plate with the same dimensions as the dimensions of the laminated layer film, a piece of the laminated layer film cut to dimensions of length of 200 mm and a width of 25 mm, was adhered, and on the top of that a 2 kg rubber roller as passed back and forth 1 time and the whole surface of the laminated layer film was adhered. After that, it was hung on a tensile test device (maker name: Orientek Company, product number: RTG-1225), and one side of the laminated layer film was pulled in the 90 degree direction relative to the film surface at a speed of 50 mm/minute, and the average value of 5 repeat pull tests was obtained and that was taken as the adhesion or bonding strength.

Measurement of the gel component fraction (ratio): Under room temperature and humidity, a test material was weighed on a scale with a 0.5 g precision (denoted as WO(g)) and this was immersed for 24 hours in 200 cc toluene, from the test material the toluene soluble component was dissolved and extracted and after that the undissolved component was taken out and washed by using acetone and after that this undissolved component was dried at 0.1 MPa pressure for 1 hour in a vacuum drying device set at 100 degrees C. (maker name: Yamato materials Company, model name: DP32), and the weight of this undissolved component was precisely weighed (denoted as W1 (g)), and the gel component fraction was calculated according to the formula:

Gel Component Fraction (%)=(W1/W0)×100

Method for producing the pierced through pores into the laminated layer film: under room temperature and humidity, according to any of the following methods:

CO2 laser: maker name: Sumitomo Juko Company, model name: IMPACT L500 (used in the case when the pierced through pore diameter is 50 microns or more at the irradiation exit side (at the radiation entrance side—it is 100 microns or higher and 500 microns or less)

Eximer laser: maker name: Sumitomo Juko Company, model number: INDEX800 (used in the case when the pore diameter on the irradiation exit side is at least 10 microns or more and less than 50 microns (on the irradiation entrance side it is at least 40 microns or more and less than 100 microns)

Punching (maker name: Jisha Seisan, produced pores with a diameter of approximately 500 microns or larger).

By the above, a laser light is irradiated from the side of the plastic film layer and an irradiation entrance or punching is conducted and pierced through pores at a pore pitch distance are produced.

Here, in the case when the pore pitch is 5.0 cm, the distance from the long or short side of the sheet to the pore is made to be 2.5 cm, and in the case when the pore pitch is less than 5 cm, the distance from the long or short side of the sheet to the pore is made to be 1.0 cm.

Adhesion imparting agent: in the case when an adhesion imparting agent is used, MQ resin (maker name: Toray Dow Corning Company, product number: BY15-710A) was used.

Laminated layer film manufacturing method: under room temperature and humidity, silicone main agent (Toray-Dow Corning Company, SD7226 (30 weight % solution of the silicone resin in toluene), crosslinking agent containing curing catalyst used for silicone (Toray-Dow Corning Company, SRX212) and as a diluting agent used in order to facilitate the coating, ethyl acetate are mixed at a ratio of 100:0.6:100 (weight ratio), correspondingly, and a 15weight % silicone coating solution, was obtained. After that, this solution was introduced into a solvent coater and as it was applied at a coating speed of 30 m/minute on the surface of the plastic film layer, at 100 degrees C. and for a period of 10 minutes, the solvent agent was evaporated and it was cured, and a laminated layer film containing a silicone rubber layer, was obtained, and after that a protective sheet (30 micron thickness OPP (Toray Company, Torefan 30-2500)) was applied onto the surface of the silicone rubber layer. After that, this laminated layer film with the protective sheet adhered on it was cut to each width of 2 200 mm×200 mm and the used for the peel testing 25 mm×200 mm.

As the laminated layer film according to a reference example, the material described here below was used.
a) Manufactured by 3M Company, Scotch Tint (trade mark) product name: RE87CLIS: it is a glass scattering preventing and commercially available manufactured product that has a sunlight isolating functionality and that contains an acrylic type adhesive layer with added in it infrared light absorption agent and ultraviolet light absorption agent, which has been coated on the surface of the PET film. This film has an adhesion strength of 500 N/cm when measured according to the 90 degree peel test, and its gel component fraction is 95% and the visible light transmittance was 85%.
b) Manufactured by 3M Company, Scotch Tint (trade mark) product name: RE80CLIS; the structure is the same as the RE87CLIS, however it is a glass scattering preventing and commercially available manufactured product that has a sunlight isolating functionality where the visible light transmittance is 81%.
c) Manufactured by 3M Company, Scotch Tint (trade mark) product name: RE18SIAR: it is a glass scattering preventing and commercially available manufactured product that has a sunlight isolating functionality where the visible light transmittance is 18%, and that is a film where Al is vapor deposited on the front surface of PET and then on the top of the Al vapor deposited layer, there is an acrylic type adhesive layer where an ultraviolet light absorption agent has been added. This film has an adhesion strength of 500 N/cm when measured according to the 90 degree peel test, and its gel component fraction is 95%.
d) A three-layer structure laminated layer material that is obtained as on the surface of a protective sheet (30 micron thickness OPP (Toray Company, Torefan 30-2500)), a material, obtained as to 100 weight parts of acrylic type adhesive agent (manufactured by Nippon Gosei Chemical Industries Company, Coponyl N-2147, solid phase: 35 weight %) 25 weight parts of ethyl acetate were compounded and after that 1 weight part of an isocyanate type crosslinking agent (manufactured by Nippon Polyurethane Industries Company), was compounded, and sufficiently stirred, was coated by the knife coating method so that the thickness after drying would become 30 microns, and it was dried at after that a 50 micron thick PET film (Lumilar 50S10 (manufactured by Toray)) was press adhered on the top. This film has an adhesion strength of 500 N/cm when measured according to the 90 degree peel test, and its gel component fraction is 95%.

### Comparative Example 1

Following the above described laminated layer manufacturing method, as a plastic film layer, a 50 micron thick PET film (Lumilar 50S10 (manufactured by Toray Company)), was used and laminated layer films, which contained silicone rubber layers with a thickness of 1.4 microns, 2.0 microns, 2.5 microns, 5.0 microns, 25 microns, 30 microns, 35 microns, were used, and these were adhered onto larger than the sample size window glass (dimensions: 220 mm square, thickness: 3 mm, maker name: Asahi Glass Company, product number: FL3) and evaluated. Regarding these laminated layer films, their adhesion strengths relative to the glass when measured according to the 90 degree peel test was correspondingly 0.3 N/m, 0.3 N/m, 0.3 N/m, 0.4 N/m, 0.7 N/m, 0.7 N/m, 0.7 N/m, and for all of them the gel component fraction was almost the same at 95%.

When these 200 mm square size samples were adhered onto manufactured from acrylic windows (dimensions: 220 mm square, thickness: 3 mm, maker name: Mitsubishi Rayon Company, product number: Acrylite) and on glass manufactured windows (dimensions: 220 mm square, thickness: 3 mm, maker name: Asahi Glass Company, product number: FL3), they adhered well and there were practically no outer appearance poor conditions observed, and the air bubbles generated at the interface with the window in the case of the materials where the thickness of the silicone rubber layer was in the range of 2.0 microns˜30 microns, could be easily removed by finger squeezing. After that, when the laminated layer films were separated according to the naked eye observation, these were clean separations and there were no adherents or adhesion traces, etc., remaining, neither on the glass nor on the acrylic surfaces subject to the adhesion. In the case of the material where the thickness of the silicone rubber layer was 1.4 microns, when exposed to an environment of air temperature of 50 degrees C. and humidity of 85% at 168 hours, the partial separation with the glass was generated. In the case of the material with a thickness of 35 microns, the solvent evaporation is insufficient and at the time when the protective sheet is separated, a partial separation between the plastic film layer and the silicone rubber layer, was generated.

### Comparative Example 2

A laminated layer film was manufactured according to the same procedures and sequence as described in the Comparative Example 1, except for the fact that the silicon rubber layer thickness was 5 microns, and a PET film containing an Al vapor deposited layer with a visible light transmittance of 18% (50 Tetrite T=18T (Bichi Kogyo Company)) was used. Samples with a dimension of 200 mm square were adhered onto glass manufactured windows and under an environment of room temperature of 20 degrees C. and a room humidity when a thermometer was placed at a distance of 10 cm from the center part of the sample materials, and the temperature was measured after it was left to stand for a period of 15 minutes under the sunlight, it was 22° C.

### Comparative Example 3

A laminated layer film was used that was manufactured according to the same procedures and sequence as described in the Comparative Example 1, except for the fact that the silicon rubber layer thickness was 5 microns and that an adhesion imparting agent was added at 10%, 15%, 20% by weight. These laminated layer films had the same gel component ratio as that in the case of the Comparative Example 1, and when measured according to the 90 degree peel test, correspondingly, the adhesion strengths were 12 N/m, 18 N/m, and 20 N/m. When the same way as in the case of the Comparative Example 1 the adhesion separation test relative to the acrylic manufactured window and the glass manufactured window were performed, the materials that contained 10 weight % and 15 weight % of the adhesion imparting agent, allowed to obtain the same good results as in the case of the Comparative Example 1, however, for the material with the 20 weight % adhesive traces were visually observed.

### Reference Example 1

When on a window glass the 200 mm square dimension films according to the above described a) through c) were adhered, air bubbles and wrinkles were generated and adhesion with good outer appearance could not be achieved. Adhesion separation was conducted, however, pulled strings were generated in the adhesive agent and the smoothness state of the adhesive agent surface was lost, and even if a repeat adhesion was conducted it was not possible to obtain a material with good outer appearance.

### Reference Example 2

On a glass manufactured window that does not have an adhered on it window adhesive laminated layer film, under an environment of room temperature of 20 degrees C. and a room humidity when a thermometer was placed at a distance of 10 cm from the window, and the temperature was measured according to the same procedures as stated in the Comparative Example 1, after it was left to stand for a period of 15 minutes under the sunlight it was 36° C.

On glass manufactured windows, films with a dimension of 200 mm square that have been manufactured according to the above described a) through c) were adhered and under an environment of room temperature of 20 degrees C. and a room humidity when a thermometer was placed at a distance of 10 cm from the center part of the sample materials, and the temperature was measured the same way as described according to the Comparative Example 1 after it was left to stand for a period of 15 minutes under the sunlight, for the infrared absorption layers containing a) RE87CLIS and b)RE8OCLIS, it was correspondingly 34 degrees C. and 32° C., and for the infrared light reflecting layer containing RE18SIAR, it was 24° C.

### Practical Examples 1˜30, Comparative Example 3, Reference Examples 3˜6

Laminated layer film was obtained under the same conditions as described according to the Comparative Example 1 except for the fact that the thickness of the silicone rubber layer was made to be 5 microns, and using the same measures as those according to the Comparative Example 1 and his film was used (Comparative Example 3) and then materials where pores were opened by using the method described as the method for producing pierced through pores into the above described laminated layer film (Practical Examples 1˜30), and materials where pierced through pores were opened by using the film obtained according to the above described d) used as a reference example (Reference Examples 3˜6), were used and samples with dimensions of 100 mm×100 mm were obtained, and these were adhered onto glass with dimensions of 120 mm×120 mm×3 mm, and the described below evaluations were performed. These films had adhesive strengths of 0.4 N/m as tested by the 90 degree peel test and the gel fraction was 95% and the content of the adhesion imparting agent was 0 weight %.

Film Strength Evaluation: If the pore diameter becomes more than approximately ½ of the pitch, the film's pull tear strength is drastically decreased and because of that it was designated as NG. The sheet strength was evaluated as one of the below described conditions.

A: it was not easy to pull and tear by hand

B: it was easy to pull and tear by hand

Air Bubble elimination evaluation: It was conducted by visual observation as the protective film was separated and after that the evaluation sheet was adhered correspondingly on the materials subject to the adhesion and then after the adhesion was completed, by using a squeegee (maker name: 3M Company, model number: PA-1) and by a manual operation, the air bubbles were pushed out; and it was evaluated as any one of the below:

A: At the instant when the film has been adhered there is a prominent shrinking of the air bubbles and by using a squeegee the diameter of the air bubbles is decreased to 100 microns or below.

B: At the instant when the film has been adhered there is no prominent shrinking of the air bubbles, however by using a squeegee the diameter of the air bubbles is decreased to 100 microns or below.

C: At the instant when the film has been adhered there is no prominent shrinking of the air bubbles, however by using a squeegee the diameter of the air bubbles is decreased to above 100 microns.

D: At the instant when the film has been adhered there is no prominent shrinking of the air bubbles, and by using a squeegee there is no change of the diameter of the air bubbles.

Evaluation of the visibility of the pierced through pores: By using the samples pieces on which the air bubbles elimination test has been conducted, the visibility of the pierced through pores was studied. Inside a room and under a fluorescent lamp and observing by naked eye an inspection was performed to confirm if it is possible to observe the pierced through pores on the front surface of the evaluation sheets. The evaluation sheets were viewed as the angle was varied and they were evaluated as any one of the following:

A: Visible in the individual film, however not visible when adhered onto the window.

B: Visible even when adhered to the window, however, not visible from a distance of 3 meters.

C: Visible even when adhered on the window and at viewed from a distance of 3 meters, or the transparency of the whole body of the film becomes poor due to the high number of the pierced through pores and/or the high number of the residual air bubbles.

The results from the conducted above described evaluations of the film strength, the air bubble elimination evaluation and the pierced through pore visibility evaluation are shown here below.

TABLE 1

| | | | Pore | | | Pierced |
|---|---|---|---|---|---|---|
| | Pore pitch | Pore diameter | manufacturing | Film | Air bubble | through pore |
| No. | (mm) | (μm) | method | strength | elimination | visibility |
| Comparative | None | None | None | A | C | — |
| Example 3 | | | | | | |
| Practical | | | | | | |
| Example | | | | | | |
| 1 | 1 | 100 | C | A | C | B |
| 2 | | 300 | C | A | B | C |
| 3 | 2 | 100 | C | A | C | B |
| 4 | | 300 | C | A | B | B |
| 5 | | 500 | P | A | A | C |
| 6 | | 700 | P | A | A | C |
| 7 | | 1000 | P | B | A | C |
| 8 | | 2000 | P | — | A | C |
| | | | | (pores have not | | |
| | | | | been formed) | | |
| 9 | 5 | 700 | P | A | A | B |
| 10 | | 1000 | P | A | A | B |
| 11 | | 2000 | P | A | A | C |
| 12 | 10 | 100 | C | A | C | A |
| 13 | | 300 | C | A | B | A |
| 14 | | 500 | P | A | A | A |
| 15 | | 700 | P | A | A | A |
| 16 | | 1000 | P | A | A | B |
| 17 | | 2000 | P | A | A | C |
| 18 | 20 | 300 | C | A | B | A |
| 19 | | 500 | P | A | A | A |
| 20 | | 700 | P | A | A | A |
| 21 | | 1000 | P | A | A | B |
| 22 | | 2000 | P | A | A | B |
| 23 | 30 | 300 | C | A | C | A |
| 24 | | 500 | P | A | B | A |
| 25 | | 700 | P | A | A | A |
| 26 | | 1000 | P | A | A | A |
| 27 | | 2000 | P | A | A | B |
| 28 | 50 | 1000 | P | A | B | B |
| 30 | 100 | 300 | C | A | C | A |
| Reference | | | | | | |
| Examples | | | | | | |
| 3 | None | None | None | A | D | — |
| 4 | 0.5 | 80 | E | A | C | B |
| 5 | | 300 | C | B | B | C |
| 6 | 0.6 | 80 | E | A | C | B |
| 7 | | 300 | C | B | B | C |
| 8 | 1 | 80 | E | A | D | A |
| 9 | | 300 | C | A | D | C |
| 10 | 2 | 80 | E | A | D | A |
| 11 | | 300 | C | A | D | C |
| 12 | 50 | 100 | C | A | D | A |
| 13 | 50 | 100 | C | A | D | A |

In the table, the pore manufacturing methods are correspondingly:
E: Eximer laser (in the case when the pore diameter is approximately 80 microns)
C: CO2 laser (in the case when the pore diameter is in the range of approximately 100 microns ~approximately 300 microns)
P: punch (in the case when the pore diameter is approximately 500 microns and above)

Regarding the practical examples films in Table 1, they are adhered through adhesive force and because of that the air bubbles can be moved at a high degree of freedom and because of that in the case when the allowed air bubble size was set as 100 microns, the elimination of air bubbles became possible even in the regions of significantly larger pore diameters and pore pitch, compared to the reference example films, to the level of pore diameters of approximately 300 microns or more, and pore pitch of 2 mm and higher. Also, in the region where the pore diameter is above approximately 300 microns and the pore pitch is less than 50 mm, the elimination of the air bubbles becomes easy, and for the region where the pore pitch is less than 30 mm, the elimination of the air bubbles becomes especially easy. Then, generally, if in the case when the pore diameter is less than 1000 microns, the pore pitch is 2 mm or higher, and if in the case when the pore diameter is at least 1000 microns or larger, the pore pitch is at least 2 times or more the pore diameter, and they span the whole body, in the case when the whole body of the window glass after the film adhesion is viewed, the decrease of the transparency is small and it is possible to suggest a film material with high aesthetic properties. Also, from the point of view of the aesthetic appearance, it is good if the pore diameter does not exceed 2000 microns, however, there are also cases where depending on the pore pitch and the type of application, the appearance aesthetics are not deteriorated.

In the case when for the films according to the reference examples in Table 1, the allowed residual air bubble size was set as 100 microns, because of the fact that adhesive agent is used, the air bubbles almost cannot be moved and because of that, these cannot be practically implemented unless it is in the region where the pore diameter is set to be approximately 300 microns or less, and the pore pitch is set to be less than 1 mm, and especially, when the pore diameter was made to be 80 microns or less, irrespective of the pore pitch, it was not possible to shrink the air bubbles to the region where the diameter is 100 microns or less. In the region where the pore diameter is approximately 300 microns or less and the pore pitch is 1 mm and less, even though the transparency of the film material is high, because of the presence of the pierced through pores, as a whole body it becomes a semi-transparent material, and after the adhesion, the transparency and the aesthetic appearance of the whole body of the window glass are decreased.

On the other hand, in the region where the pore diameter is above approximately 300 microns and the pore pitch is above 1 mm, even though the film itself is a high transparency material, because of the remaining fine air bubbles, after the adhesion, the transparency and the aesthetic appearance of the whole body of the window glass are decreased.

### Practical Example 31

500 mm×750 mm piece of laminated layer film where the pore pitch is 10 mm and also the pore diameter is 500 microns, and the thickness of the silicone rubber layer is 5.0 microns, is adhered onto 800 mm×2000 mm aluminum sash adhered glass and an evaluation was performed. According to that evaluation, the film's strength evaluation was A, the air bubbles elimination evaluation was A and the pierced through pore visibility evaluation was A. For this film, the adhesive strength as measured according to the 90 degree peel test, the gel fraction and the adhesion imparting agent content were the same as those in the case of the Practical Example 1.

### Practical Examples 32˜33

According to the Practical Example 31, the silicone rubber layer curing conditions were changed to 10 minutes at a temperature of 120 degrees C. and 10 minutes at a temperature of 130 degrees C. and the obtained by that materials with a corresponding gel fraction only of 99% (Practical Example 32) and gel fraction only 99.8% (Practical Example 33), were used; and when these films were separated after that the transfer of the silicone rubber layer on the glass front surface, namely, the adhesion trace evaluation was conducted.

Here, the evaluation of the adhesive traces was conducted as 8 pieces of each Practical Examples layer laminated film with dimensions of 500 mm×750 mm were adhered onto 800 mm×2000 mm aluminum sash adhered glass, and after leaving them to stand for 2 days these were separated and the adhesive traces were evaluated visually.

For the material with a gel fraction of 99% (Practical Example 31), there were no adhesive traces observed, however, for 1 piece a slight separation was observed between the silicone rubber layer and the plastic film layer. Then, for the material with the gel fraction of 99.8% (Practical Example 32), there were no adhesive traces observed.

This way, in the case of the laminated layer films according to the Practical Examples 31˜33, even for large sizes, it is possible to have sufficient air bubble elimination, and the pierced through pore visibility evaluation result is good and because of that in the case when after the adhesion, the whole body of the window glass is viewed, the decrease of the transparency level is small, and it is possible to suggest a film with high aesthetic appearance, and the higher the gel fraction ratio is the smaller the adhesion residue and adhesive traces on the front surface of the glass are.

### Practical Example 34

Adhesion Operation Time Measurement Test:

By using a laminated layer film where the film dimensions are 750 mm×900 mm and the thickness of the silicone rubber layer is 0.5 microns (Comparative Example 1), three types of samples were produced as a material that does not have pierced through pores was used and then by using a punch (maker name: Onozuka Company) using punching tools with a diameter of 500 microns and a diameter of 700 microns, pierced through pores were opened with a diameter of 500 microns and a pore pitch of 10 mm and also with a pore diameter of 700 microns and at a pore pitch of 10 mm. Building plate glass window (longitudinal dimension: 3.0 m, width dimension: 2.0 m) was water wiped by using Scotch Brite (trade mark) kitchen power towel (maker name: Sumitomo 3M Company, product number: KPF-01) and by using the below described procedures, the time required to adhere the above described three types of samples, was measured.

There were three operators—A, B and C.

The liner of the laminated layer film was removed in advance, and the measurement time included only the time required for the adhesion.

The film that did not have pierced through pores, the film with pore diameter of 500 microns and a pore pitch of 10 mm and the film with pore diameter of 700 microns and pore pitch of 10 mm were adhered in order.

The operators confirmed that there were no air bubbles with a diameter of 5 mm or larger and no retained water and completed the process.

The measurement results are presented in table 2.

TABLE 2

| | Film that | | |
|---|---|---|---|
| | did not | Film with | Film with |
| | have pierced | pore diameter of | pore diameter |
| | through | 0.5 mm and a pore | of 0.7 mm and pore |
| Operator | pores | pitch of 10 mm | pitch of 10 mm |
| A | 5 minutes, | 1 minute, 35 seconds | 1 minute, 25 seconds |
| | 0 seconds | | |
| B | 5 minutes, | 1 minute, 15 seconds | 1 minute, 15 seconds |
| | 5 seconds | | |
| C | 3 minutes, | 1 minute, 55 seconds | 1 minute, 50 seconds |
| | 55 seconds | | |
| Average | 4 minutes, | 1 minute, 33 seconds | 1 minute, 30 seconds |
| time | 40 seconds | | |
| Relative | 100% | 33% | 32% |
| time | | | |

If the average time for the adhesion is compared, the adhesion operation time for the film that did not have pierced through pores was 4 minutes and 40 seconds, however, in the case of the film with pore diameter of 500 microns and a pore pitch of 10 mm, it was shortened to 1 minute and 33 seconds (77% decrease, namely 33%), and for the film with pore diameter of 700 microns and pore pitch of 10 mm it was shortened to 1 minute and 30 seconds (a decrease of 78%, namely 32%), and in the films that contained pierced through pores, significant results for the expulsion of the air bubbles and water were confirmed.

As it is clear from the above described, in the case of the pierced through pore containing, window adhesion laminated layer film according to these practical implementation conditions shown in the practical examples, they can be easily adhered even on large surface area windows, and then, they have good adhesion and separation properties and not only that but also, even after the separation there are no residues of the silicone rubber layer or adhesive traces and they show excellent results.

1. Window adhesion laminated layer film, comprising: a plastic film layer,
and a silicone rubber layer, which has a surface that adheres to the window,
and wherein the window adhesive laminated layer film includes 1 or more pierced through pores per 100 cm square; and
wherein the above described silicone rubber layer does not have adhesive properties or bonding properties.

2. Window adhesion laminated layer film according to the claim 1 where the diameter of the pierced through pores is 300 microns or above and also is 2000 microns or less, and then, the minimum value of the pitch of the above described pierced through pores is the larger value between 2 mm and 2 times the diameter of the pierced through pores.

3. Window adhesion laminated layer film according to the claim 2 where the pierced through pore pitch is then 30 mm or less.

4. Window adhesion laminated layer film according to claim 3, wherein the silicone rubber layer has a thickness that is in the range of at least 0.5 microns or higher and 30 microns or less.

5. Window adhesion laminated layer film according to claim 4, wherein the silicone rubber layer has a thickness that is in the range of at least 1.0 microns or higher and 20 microns or less, and then where the gel component ratio is at least 99.8% or higher, and then it does not contain adhesion imparting agent.

6. Window adhesion laminated layer film according to claim 5, further comprising an infrared light reflecting layer.

7. Window adhesion laminated layer film according to claim 6, further comprising a printing layer.
